(19) United States
(12) Patent Application Publication
(10) Pub. No.: US 2025/0110702 A1
(43) Pub. Date: Apr. 3, 2025

(54) Microservice Orchestration Method and Apparatus

(71) Applicant: Siemens Aktiengesellschaft, München (DE)

(72) Inventors: Hang Xiao, Qingdao (CN); Jian Lin, Chengdu (CN); Bo Wen Wang, Jining (CN)

(73) Assignee: Siemens Aktiengesellschaft, München (DE)

(21) Appl. No.: 18/851,488

(22) PCT Filed: Mar. 30, 2022
(86) PCT No.: PCT/CN2022/084087

§ 371 Date: Sep. 26, 2024

(51) Int. Cl. G06F 8/20; G06F 8/34; G06F 8/36; G06F 8/41

(52) U.S. Cl. CPC G06F 8/20; G06F 8/34; G06F 8/36; G06F 8/427

(57) ABSTRACT

Embodiments of this application mainly relate to the field of data processing technologies, and in particular, to microservice orchestration methods and apparatus, electronic devices, and readable media. A first node is established in a first runtime for each of a plurality of microservices. The first node is configured to control execution of the microservice. Construction performed by a user on a behavior tree is received. The behavior tree includes a leaf node, and the leaf node represents the microservice. The behavior tree is parsed, where the leaf node is mapped to the first node. An instance of the behavior tree is generated.

### CROSS-REFERENCE TO RELATED APPLICATIONS

This application is a U.S. National Stage Application of International Application No. PCT/CN2022/084087 filed Mar. 30, 2022, which designates the United States of America, the contents of which are hereby incorporated by reference in their entirety.

### TECHNICAL FIELD

Embodiments of this application mainly relate to the field of data processing technologies. Various embodiments of the teachings herein include microservice orchestration methods and/or apparatus, electronic devices, and readable media.

### BACKGROUND

A microservice is an architecture and an organization method for developing software, wherein the software is composed of small independent services that communicate through a well-defined application programming interface (API). The microservice is a widely used architecture nowadays. As microservices increase, it is increasingly difficult to orchestrate the microservices. Currently, microservices are orchestrated in a fixed order and then run; a corresponding workflow is run in a service chain. However, if a service needs to be modified or a new service needs to be introduced into the service chain in the above manner, the related development and deployment will be very cumbersome and complex.

### SUMMARY

Embodiments of this application mainly provide a microservice orchestration method and apparatus, an electronic device, and a readable medium, to flexibly orchestrate different microservices.

As an example, some embodiments include a microservice orchestration method, including: establishing, for each of a plurality of microservices, a first node in a first runtime, where the first node is configured to control execution of the microservice; receiving construction performed by a user on a behavior tree, where the behavior tree includes a leaf node, and the leaf node represents the microservice; parsing the behavior tree, where the leaf node is mapped to the first node; and generating an instance of the behavior tree.

As another example, some embodiments include an electronic device, including: at least one memory, configured to store computer readable code; and at least one processor, configured to call the computer readable code to perform one or more of the methods described herein.

As another example, some embodiments include a computer readable medium storing computer readable instructions. The computer readable instructions, when executed by a processor, cause the processor to perform one or more of the methods described herein.

As another example, some embodiments include a microservice orchestration apparatus, including components for performing one or more of the methods described herein.

### BRIEF DESCRIPTION OF THE DRAWINGS

The following drawings are merely intended to give schematic illustrations and explanations of embodiments of this application and are not intended to limit the scope of the embodiments of this application. In the drawings:

FIG. 1 is a flowchart of an example microservice orchestration method incorporating teachings of the present disclosure;

FIG. 2 is a schematic diagram of an example microservice orchestration method incorporating teachings of the present disclosure;

FIG. 3 is a schematic diagram of another example microservice orchestration method incorporating teachings of the present disclosure;

FIG. 4 is a schematic diagram of an example electronic device incorporating teachings of the present disclosure; and

FIG. 5 is a schematic diagram of an example microservice orchestration apparatus incorporating teachings of the present disclosure.

### REFERENCE NUMERALS

100: Microservice orchestration method 101-104: Step of method
400: Electronic device 401: Processor 402: Memory
50: Microservice orchestration apparatus 51: Establishment module 52: Receiving module
53: Parsing module 54: Instantiation module

### DETAILED DESCRIPTION

Discussion of the various examples and implementations herein is merely intended to make a person skilled in the art better understand and implement the subjects described in this specification, and is not intended to limit the protection scope of the claims, the applicability, or examples. Changes may be made to the functions and arrangements of the discussed elements without departing from the scope of the present disclosure. Various processes or components may be omitted, replaced, or added in each example according to requirements. For example, the described method may be performed according to a sequence different from the sequence described herein, and steps may be added, omitted, or combined. In addition, features described in some examples may be combined in other examples.

As used in this specification, the term “include” and variants thereof represent open terms, and mean “include but is not limited to”. The term “based on” represents “at least partially based on”. The terms “one embodiment” and “an embodiment” represent “at least one embodiment”. The term “another embodiment” represents “at least one another embodiment”. The terms “first”, “second”, and the like may represent different objects or the same object. Other definitions may be included explicitly or implicitly in the following. Unless otherwise clearly specified, the definition of one term is consistent in the entire specification.

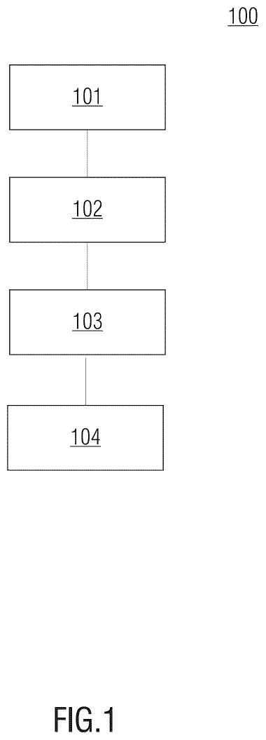

FIG. 1 is a flowchart of an example microservice orchestration method incorporating teachings of the present disclosure. As shown in FIG. 1, the microservice orchestration method 100 includes:

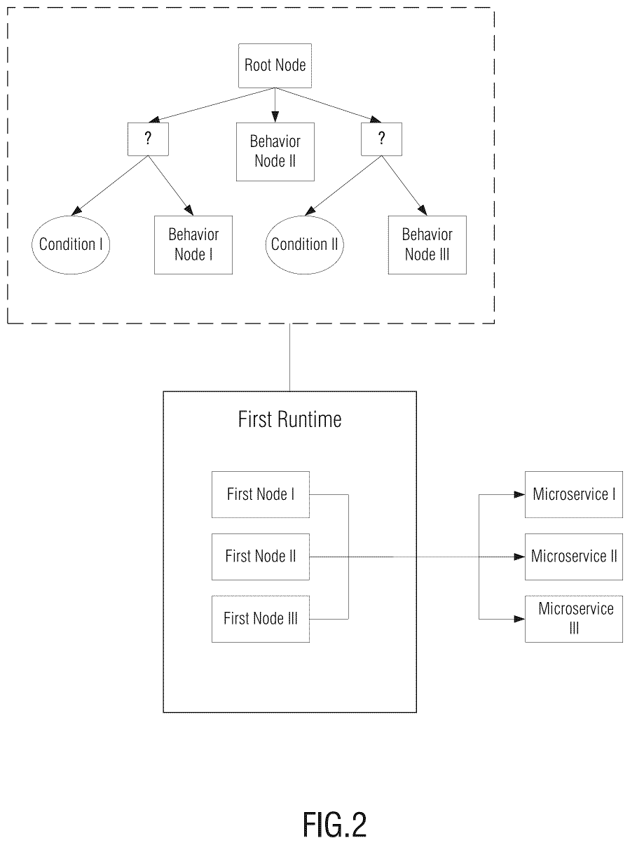

Step 101: Establish, for each of a plurality of microservices, a first node in a first runtime, where the first node is configured to control execution of the microservice. The first node communicates with the corresponding microservice through a RESTful application programming interface (API) or a remote procedure call (RPC) API. In some embodiments, as shown in FIG. 2, a first node I, a first node II, and a first node III in the first runtime are respectively configured to control execution of corresponding microservices. The first node I controls execution of a microservice I, the first node II controls execution of a microservice II, and the first node III controls execution of a microservice III.

Step 102: Receive construction performed by a user on a behavior tree, where the behavior tree includes a first leaf node, and the first leaf node represents the corresponding microservice. The first leaf node is a behavior node. The behavior tree is a formalized graphical modeling language, which explicitly represents hundreds of or even thousands of natural language requirements through well-defined symbols. The requirements are usually used to express demands of users of large-scale software integration systems. An execution order of each node is usually defined in the behavior tree. As shown in FIG. 2, a user may create a corresponding behavior tree according to a demand for an actual control logic. Optionally, the first leaf node may include a name or an identifier of a function of a corresponding microservice.

In some embodiments, a plurality of leaf nodes may be created in the behavior tree according to specific requirements, which correspond to different functions of the same microservice or correspond to different microservices. Optionally, when a configuration operation performed by the user on the first leaf node is received, or according to a preset configuration operation of a system, where the configuration includes relevant parameters during execution of the corresponding microservice, the execution of the corresponding microservice may be controlled through the corresponding first node according to the specific configuration when the first leaf node is ticked. In an embodiment, it is assumed that a function of a microservice is to grab a component A.

According to a call rule defined for the microservice, which specifically includes a type and a parameter of an acceptable request message, such as a grab strength, a movement speed, and a movement position, the user inputs a specific configuration requirement in the corresponding leaf node. When the first leaf node is ticked, the corresponding first node establishes corresponding request information. The request information includes the parameters for the microservice to grab the component A after receiving the corresponding request information.

In some embodiments, in the field of industrial control, a related operational technology (OT) device connected in the first runtime may be controlled to perform a specific operation in response to the configuration operation performed by the user. In some embodiments, the microservice includes a runtime. The corresponding OT device may be directly controlled through the runtime in the microservice to perform specific operation in response to the configuration operation performed by the user.

Step 103: Parse the behavior tree, where the first leaf node is mapped to the first node. Specifically, a control logic in the behavior tree may be transmitted to the first runtime to parse the control logic in the behavior tree. In some embodiments, a destination address of the first leaf node, that is, an address and configuration information of a target device, may be mapped to the first node in the first runtime according to a name or an identifier of a function of the corresponding microservice included in the leaf node.

Step 104: Generate an instance of the behavior tree. The behavior tree may be instantiated through the first runtime. The first runtime is configured to deploy the control logic in the behavior tree. In some embodiments, the first runtime deploys control logic of a related leaf node to a corresponding target device according to a destination address of the related leaf node in the behavior tree.

In this embodiment of this application, corresponding nodes are established to control the execution of different microservices, and then the established nodes are mapped to the corresponding leaf nodes in the behavior tree, so that the definition of the control logic in the behavior tree is fully used to orchestrate the different microservices. A coupling degree between different microservices is significantly reduced, and a logical coupling relationship is decoupled to the behavior tree. Since logic processing of the behavior tree conforms to a tick algorithm thereof, a business coupling degree between a product designer and a developer is significantly reduced.

During construction of a new service, the product designer realizes maximum re-orchestration of microservices by constructing different behavior trees, which does not require secondary development of the microservices. Rapid development and deployment of the new service can be realized through only visual definition and construction of the behavior tree. The product developer only needs to develop rich related nodes such as code blocks or classes according to interfaces of microservices, without a need to pay attention to a specific service coupling logic.

During service upgrade, if no new microservice and an API change or a new API introduction are involved, the product designer only needs to upgrade a logic of a behavior tree. If only optimization of the microservice is involved and no API change is involved, just single-point upgrading needs to be performed on the corresponding microservice. If the API change is involved, the microservices and orchestration policies may be upgraded separately. Therefore, labor costs can be significantly reduced through the embodiments of this application.

In some embodiments, an operating interface is provided, in which the user may create and update a corresponding behavior tree. During execution of a workflow, a node of a behavior tree currently in execution is displayed on the operating interface in a preset annotation manner, so that the user can learn an execution progress and an execution status.

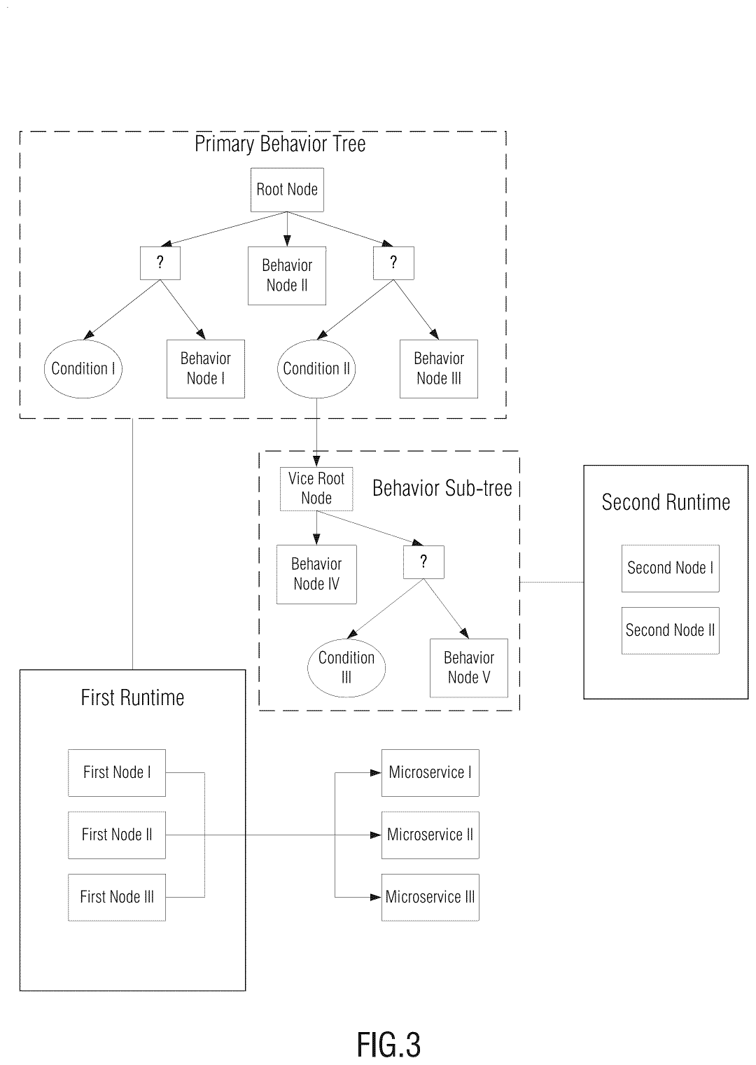

In some embodiments, before the instance of the behavior tree is generated, as shown in FIG. 3, FIG. 3 is a schematic diagram of another microservice orchestration method, in which at least one behavior sub-tree may be connected to a primary behavior tree. Distributed deployment is performed on a second runtime connected to the at least one behavior sub-tree and the first runtime connected to the primary behavior tree. The first runtime is connected to the second runtime so that the first runtime controls execution of the second runtime.

A corresponding second node is established in the second runtime for each of all behavior nodes in a behavior sub-tree of the at least one behavior sub-tree. The behavior node defines an operation of an OT device, so that a corresponding OT device is controlled by the second node when the behavior node in the behavior sub-tree is ticked. Optionally, communication between the primary behavior tree and the behavior sub-tree may be established through an RPC standard.

In some embodiments, in a scenario of monitoring objects on a conveyor belt, a first behavior sub-tree for image recognition may be caused to communicate with a runtime installed in a computing device A, to control a related OT device to complete an image recognition operation. A second behavior sub-tree for object detection is caused to communicate with a runtime installed in a computing device B, to control a related OT device to complete object detection.

In some embodiments, at least one second node may be connected to a microservice in the second runtime, so that the second node controls execution of the microservice. That is to say, the microservice may be called in either the primary behavior tree or the behavior sub-tree.

In some embodiments, a leaf node may be determined from the primary behavior tree, where the leaf node is configured to control execution of a behavior sub-tree. A root node of each of the at least one behavior sub-tree to a corresponding leaf node in the primary behavior tree. The root node of each of the at least one behavior sub-tree may be caused to communicate with the corresponding leaf node in the primary behavior tree through the RESTful API or the RPC API.

With the advent of the open distributed industrial control system, increasing complex control logics are divided into different functional blocks, which are deployed on the distributed system and communicate with an IP network technology. This embodiment of this application accords with the current distributed development. Since the behavior sub-trees are connected to the primary behavior tree and are respectively connected to different runtimes in the distributed deployment, the existing software does not need to be developed completely, and only a newly added behavior tree design part needs to be deployed. In this embodiment of this application, program designing is separated from development. When a new behavior sub-tree needs to be added to the original behavior tree, the new behavior sub-tree is deployed to a runtime, without a need to stop running of any other original programs. Either reconfiguring or reconstructing the control logic is more efficient and flexible, which saves huge capital and human resources. In addition, the distributed deployment also reduces a requirement for the computing capability of a device. The user may deploy a control logic with a high timeliness requirement on a site and deploy a control logic with a low timeliness requirement on a cloud.

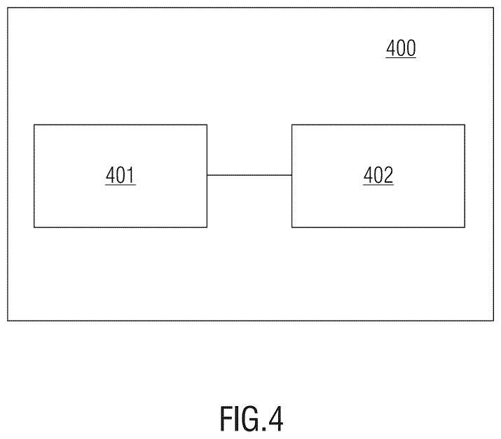

Some embodiments include an electronic device. FIG. 4 is a schematic diagram an example of electronic device 400 incorporating teachings of the present disclosure. As shown in FIG. 4, the electronic device 400 includes a processor 401 and a memory 402. The memory 402 stores instructions. The instructions, when executed by the processor 401, implement the method 100 described above. The at least one processor 401 may include a microprocessor, an application specific integrated circuit (ASIC), a digital signal processor (DSP), a central processing unit (CPU), a graphics processing unit (GPU), a state machine, and the like. Embodiments of a computer-readable medium include, but are not limited to, a floppy disk, a CD ROM, a disk, a memory chip, a ROM, a RAM, an ASIC, a configured processor, an all-optical medium, all tapes or other magnetic media, or any other media from which a computer processor can read instructions. In addition, various other forms of computer-readable media may transmit or carry instructions to a computer, which includes a router, a private or public network, or other wired and wireless transmission devices or channels. The instructions may include code from any computer programming language, including C, C++, C language, Visual Basic, java, and JavaScript.

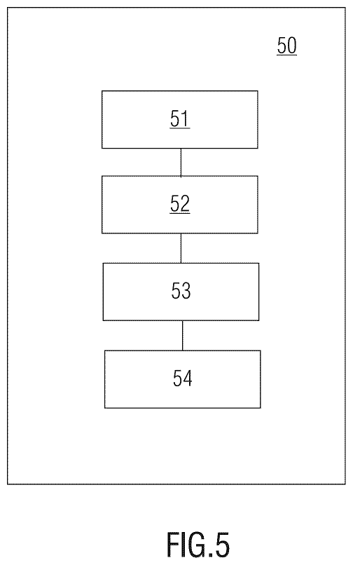

FIG. 5 is a schematic diagram of an example microservice orchestration apparatus incorporating teachings of the present disclosure. As shown in FIG. 5, the microservice orchestration apparatus 50 includes: an establishment module 51, configured to establish, for each of a plurality of microservices, a first node in a first runtime, where the first node is configured to control execution of the microservice; a receiving module 52, configured to receive construction performed by a user on a behavior tree, where the behavior tree includes a leaf node, and the leaf node represents the corresponding microservice; a parsing module 53, configured to parse the behavior tree, where the leaf node is mapped to the first node; and an instantiation module 54, configured to generate an instance of the behavior tree.

Some embodiments include a computer-readable medium storing computer-readable instructions. The computer-readable instructions, when executed by a processor, cause the processor to perform one or more of the microservice orchestration methods described herein. Embodiments of the computer-readable medium include: a floppy disk, a hard disk, a magneto-optical disk, an optical disk (such as a CD-ROM, a CD-R, a CD-RW, a DVD-ROM, a DVD-RAM, a DVD-RW, or a DVD+RW), a magnetic tape, a non-volatile memory card, and a ROM. In some embodiments, the computer readable instructions may be downloaded from a server computer or a cloud through a communication network.

It should be noted that not all steps and modules in the above processes and diagrams of the system structures are necessary, and some steps or modules may be omitted according to an actual requirement. An execution sequence of the steps is not fixed and may be adjusted as required. The system structure described in the embodiments may be a physical structure or a logical structure. That is to say, some modules may be implemented by the same physical entity, or some modules may be implemented by a plurality of physical entities or may be jointly implemented by some components in a plurality of independent devices.

What is claimed is:

1. A microservice orchestration method comprising:
establishing, for each of a plurality of microservices, a first node in a first runtime, wherein the first node is configured to control execution of the microservice;
receiving construction performed by a user on a behavior tree, wherein the behavior tree comprises a leaf node, and the leaf node represents the microservice;
parsing the behavior tree, wherein the leaf node is mapped to the first node; and
generating an instance of the behavior tree.

2. The method according to claim 1, wherein the first node communicates with the corresponding microservice through a RESTful application programming interface (API) or a remote procedure call (RPC) API.

3. The method according to claim 1, further comprising, after receiving construction performed by a user on a behavior tree, configuring the leaf node so that the execution of the corresponding microservice is controlled through the first node according to the configuration when the leaf node is ticked.

4. The method according to claim 1, further comprising, before generating an instance of the behavior tree:
connecting at least one behavior sub-tree to the behavior tree;
performing distributed deployment on a second runtime connected to the at least one behavior sub-tree and the first runtime connected to the behavior tree;
connecting the first runtime to the second runtime so that the first runtime controls execution of the second runtime; and
establishing, for each of all behavior nodes in a behavior sub-tree of the at least one behavior sub-tree, a corresponding second node in the second runtime, wherein the behavior node defines an operation of an operational technology (OT) device, so that a corresponding OT device is controlled through the second node when the behavior node in the behavior sub-tree is ticked.

5. The method according to claim 4, further comprising, after establishing a corresponding second node in the second runtime, connecting at least one second node to the microservice in the second runtime so the second node controls execution of the microservice.

6. The method according to claim 4, wherein connecting at least one behavior sub-tree to the behavior tree comprises:
determining a leaf node from the behavior tree, wherein the leaf node is configured to control execution of a behavior sub-tree; and
connecting a root node of each of the at least one behavior sub-tree to a corresponding leaf node in the behavior tree.

7. The method according to claim 6, wherein connecting a root node of each of the at least one behavior sub-tree to a corresponding leaf node in the behavior tree comprises causing the root node of each of the at least one behavior sub-tree to communicate with the corresponding leaf node in the behavior tree through a RESTful API or an RPC API.

8. An electronic device; comprising:
a processor; and
a memory storing computer-readable instructions,
wherein the instructions, when executed by the processor:
establish, for each of a plurality of microservices, a first node in a first runtime, wherein the first node is configured to control execution of the microservice;
receive construction performed by a user on a behavior tree, wherein the behavior tree comprises a leaf node, and the leaf node represents the microservice;
parse the behavior tree, wherein the leaf node is mapped to the first node; and
generate an instance of the behavior tree.

9-10. (canceled)
